(19) United States
(12) Patent Application Publication
(10) Pub. No.: US 2025/0109324 A1
(43) Pub. Date: Apr. 3, 2025

(54) CURING AGENT FOR EPOXY RESIN, AND ADHESIVE

(71) Applicant: Sunstar Engineering Inc., Osaka (JP)

(72) Inventors: Toshio KOBAYASHI, Osaka (JP); Tsuyoshi NAKATSUJI, Osaka (JP); Tatsuya OKUNO, Osaka (JP)

(73) Assignee: Sunstar Engineering Inc., Osaka (JP)

(21) Appl. No.: 18/835,610

(22) PCT Filed: Jan. 24, 2023
(86) PCT No.: PCT/JP2023/002086

§ 371 Date: Aug. 2, 2024

(30) Foreign Application Priority Data
Feb. 9, 2022 (JP) 2022-018795

(51) Int. Cl. C09J 163/00; C09J 11/06; C09J 11/08

(52) U.S. Cl. CPC C09J 163/00; C09J 11/06; C09J 11/08

(57) ABSTRACT

Excellent adhesive strength can be maintained to improve product reliability, even after storage under high humidity, by a curing agent (B) for an epoxy resin, the curing agent (B) containing a reactive terminated polydiene (B1), a reactive polyamine (B2), and an amidine (B3).

### TECHNICAL FIELD

The present disclosure relates to a curing agent for an epoxy resin and an adhesive.

### BACKGROUND ART

In recent years, in the fields of automobiles, industrial machines, home electric appliances, buildings, and the like, in order to ensure high reliability (for example, high strength and high impact strength) of products, use of a high-quality adhesive has become widespread in place of a conventional joining method (such as screw tightening or welding) or in combination with a conventional joining method. For example, in order to enhance safety of an automobile, an automobile production method in which welding and an adhesive are used in combination for assembly to improve vehicle body rigidity has become widespread.

Patent Document 1 discloses that use of a curing agent obtained by combining an aliphatic alicyclic polyetheramine (1), phenalkamine or a predetermined polyamine (2), and at least one amine compound (3) selected from an amine-terminated rubber and a predetermined amine-terminated polyether can provide an epoxy adhesive composition having structural durability and collision resistance and capable of exhibiting excellent mechanical strength.

### PRIOR ART DOCUMENT

### Patent Document

Patent Document 1: WO 2014/072449

### SUMMARY OF THE INVENTION

### Problems to be Solved by the Invention

However, the inventors of the present application have found that the bond strength cannot necessarily be sufficiently maintained under high humidity (for example, under high temperature and high humidity) by bonding using a conventional epoxy resin adhesive. It is not unusual that a bonded product is stored under high humidity, and it is strongly desired to maintain good bond strength even after storage under high humidity in order to improve reliability of the product.

### Solutions to the Problems

Exemplary aspects of the present disclosure are as follows.

### [Item 1]

A curing agent (B) for an epoxy resin, comprising: a reactive terminated polydiene (B1); a reactive polyamine (B2); and an amidine (B3).

### [Item 2]

The curing agent (B) according to item 1, wherein the reactive terminated polydiene (B1) has a repeating unit derived from acrylonitrile, and a terminal reactive group is at least one group selected from a group consisting of a hydroxy group, a carboxy group, and an amino group.

### [Item 3]

The curing agent (B) according to item 1 or 2, wherein the reactive terminated polydiene (B1) is a butadiene-acrylonitrile copolymer having an amino group at a terminal, and has an active hydrogen equivalent of 500 or more and 2,000 or less.

### [Item 4]

The curing agent (B) according to any one of items 1 to 3, wherein the reactive polyamine (B2) comprises a polyether polyamine (B2-1) and a non-polyether-modified polyamine (B2-2).

### [Item 5]

The curing agent (B) according to any one of items 1 to 4, wherein the amidine (B3) is a bicyclic heterocyclic compound and is a tertiary amine having no primary amino group and no secondary amino group.

### [Item 6]

The curing agent (B) according to any one of items 1 to 5, wherein the amidine (B3) is a phenol salt of diazabicycloundecene or a phenol salt of diazabicyclononene.

### [Item 7]

The curing agent (B) according to any one of items 1 to 6, further comprising a non-amidine tertiary amine (B4) having no primary amino group and no secondary amino group.

### [Item 8]

The curing agent (B) according to any one of items 1 to 7, further comprising an amino group-containing silane coupling agent (B5).

### [Item 9]

The curing agent (B) according to any one of items 1 to 8, wherein, with respect to 100 parts by weight of the reactive terminated polydiene (B1), an amount of the reactive polyamine (B2) is 10 parts by weight or more and 300 parts by weight or less, and an amount of the amidine (B3) is 1 part by weight or more and 100 parts by weight or less.

### [Item 10]

An adhesive, comprising: an epoxy resin (A); and a curing agent (B), wherein the curing agent (B) comprises a reactive terminated polydiene (B1), a reactive polyamine (B2), and an amidine (B3).

### [Item 11]

The adhesive according to item 10, wherein the adhesive is of a two-component type or a multi-component type in which the epoxy resin (A) and the curing agent (B) are mixed upon use.

### [Item 12]

The adhesive according to item 10 or 11, wherein curing is performed at a curing temperature of 75° C. or lower.

### [Item 13]

The adhesive according to any one of items 10 to 12, comprising a long-chain hydrocarbon group-containing phenol (C).

### [Item 14]

The adhesive according to item 13, wherein an amount of the long-chain hydrocarbon group-containing phenol (C) is 0.5 wt % or more and 10 wt % or less in the adhesive.

### [Item 15]

The adhesive according to any one of items 10 to 14, comprising rubber particles (D).

### [Item 16]

The adhesive according to any one of items 10 to 15, wherein a ratio of a number of epoxy groups to a number of active hydrogen of an amine in the adhesive is 0.5 to 2.0.

### Effects of the Invention

Use of the adhesive containing the curing agent (B) for an epoxy resin in the present disclosure as a component can realize bonding capable of maintaining good bond strength even after a bonded product is stored under high humidity.

### DETAILED DESCRIPTION

### <Adhesive>

An adhesive in the present disclosure comprises an epoxy resin (A) and a curing agent (B). The adhesive may further comprise at least one selected from a cardanol compound (C), rubber particles (D), a filler (E), and other components (F).

### [Epoxy Resin (A)]

The adhesive in the present disclosure comprises an epoxy resin (A). The epoxy resin (A) is a compound containing more than one epoxy group on average in the molecule. The epoxy resin (A) may or may not have an active hydrogen-containing group or an active hydrogen-reactive group in addition to the epoxy group.

The epoxy resin (A) may be a liquid or a solid at room temperature.

The epoxy resin (A) may be an aliphatic epoxy resin, an aromatic epoxy resin, or a combination of an aliphatic epoxy resin and an aromatic epoxy resin, and preferably comprises an aromatic epoxy resin. The epoxy resin (A) may be a linear epoxy resin, a branched epoxy resin, a cyclic (alicyclic or aromatic) epoxy resin, or a combination thereof.

Examples of the epoxy resin (A) include bisphenol type epoxy resins; glycidyl ether type epoxy resins; glycidylamine type epoxy resins; glycidyl ester type epoxy resins; novolac type epoxy resins such as phenol novolac type epoxy resins and cresol novolac type epoxy resins; aromatic epoxy resins such as naphthalene type, biphenyl type, triphenylmethane type, dicyclopentadiene type, fluorene type, and anthracene type epoxy resins; alicyclic epoxy resins such as norbornene type epoxy resins and adamantane type epoxy resins; aliphatic chain epoxy resins; phosphorus-containing epoxy resins; and alkylphenol type epoxy resins; and modified epoxy resins such as urethane-modified and acrylic-modified epoxy resins thereof. These may be used alone or two or more of these may be used in combination. The epoxy resin (A) preferably comprises a bisphenol type epoxy resin (for example, bisphenol A type) from the viewpoint of adhesiveness, adhesion moisture resistance, and curing characteristics, and particularly preferably comprises both a bisphenol type epoxy resin and a glycidyl ester type epoxy resin.

Examples of the epoxy resin (A) include an aromatic glycidyl ether type epoxy resin (for example, a phenol type epoxy resin or an ether type epoxy resin having one aromatic ring) obtained by reaction of epihalohydrin with a polyhydric phenol such as bisphenol A, bisphenol F, bisphenol S, hexahydrobisphenol A, tetramethylbisphenol A, catechol, resorcin, trihydroxybiphenyl, benzophenone, or hydroquinone; an aliphatic glycidyl ether type epoxy resin obtained by reaction of epihalohydrin with an aliphatic polyhydric alcohol such as glycerin, neopentyl glycol, ethylene glycol, or polyethylene glycol; a glycidyl ester type epoxy resin derived from a carboxylic acid such as a dimer acid glycidyl ester, phthalic acid, hydrogenated phthalic acid, tetrahydrophthalic acid, endomethylene tetrahydrophthalic acid, trimellitic acid, a polymerized fatty acid, p-oxybenzoic acid, or oxynaphthoic acid; an aromatic type such as N,N-diglycidyl-4-(glycidyloxy) aniline, 4,4′-methylenebis[N,N-bis(oxiranylmethyl) aniline], triglycidyl-o-aminophenol, or triglycidyl-p-aminophenol; a glycidylamine type epoxy resin derived from an amine such as 1,3-bis (N,N-diglycidylaminomethyl)cyclohexane, aniline, toluidine, tribromoaniline, xylylenediamine, 4,4′-diaminodiphenylmethane, aminophenol, aminoalkylphenol, or aminobenzoic acid; a polyfunctional novolac type epoxy resin obtained by multinucleation of bisphenol A or bisphenol F; an acrylonitrile-butadiene copolymer-modified epoxy resin produced by blending a carboxyl-terminated butadiene-acrylonitrile copolymer rubber and a bisphenol type epoxy resin at a mass ratio of, for example, 1:5 to 4:1, preferably 1:3 to 3:2, followed by reaction; an alkylene oxide-modified epoxy resin obtained by reaction of epihalohydrin with a polyhydroxy compound (for example, a polyalkylene glycol (such as polyethylene glycol, polypropylene glycol, or polyethylene propylene glycol); an aliphatic polyhydroxy compound such as hexylene glycol, butylene glycol, propylene glycol, ethylene glycol, neopentyl glycol, triethylene glycol, pentanediol, hexanetriol, or glycerol); a urethane-modified epoxy resin obtained by reaction of an epoxy resin with a polyurethane prepolymer having polyisocyanate added to a terminal of polyalkylene glycol; an acrylic-modified epoxy resin obtained by reaction of an epoxy resin with a carboxyl group on the surface of an acrylic rubber particle. These may be used alone or two or more of these may be used in combination.

The weight average molecular weight of the epoxy resin (A) may be 100 or more, 500 or more, 1,000 or more, 3,000 or more, 5,000 or more, 7.000 or more, or 10,000 or more. The weight average molecular weight of the epoxy resin (A) may be 100,000 or less, 50,000 or less, 30,000 or less, 10,000 or less, 5,000 or less, 3,000 or less, 2,000 or less, 1,000 or less, or 500 or less.

The epoxy equivalent of the epoxy resin (A) may be 50 or more, 75 or more, 100 or more, 125 or more, 150 or more, or 200 or more for at least one, all, or an average of the epoxy resins used. The epoxy equivalent of the epoxy resin may be 1,000 or less, 750 or less, 500 or less, or 300 or less for at least one, all, or an average of the epoxy resins used.

As the epoxy resin (A), commercially available products can be used. Examples of the commercially available products thereof include “jER 828” and “jER 871” manufactured by Mitsubishi Chemical Corporation, “ADEKA RESIN EPR-4023”, “ADEKA GLYCIROL ED-506”, “ADEKA RESIN EPU-6” and “EPU-78-11” manufactured by ADEKA CORPORATION, and “Kane Ace MX-257” manufactured by KANEKA CORPORATION.

### [Curing Agent (B)]

An adhesive in the present disclosure comprises a curing agent (B). The curing agent (B) is a curing agent for an epoxy resin. The curing agent (B) comprises a reactive terminated polydiene (B1), a reactive polyamine (B2), and an amidine (B3). By selecting a combination of these curing agent components, the adhesive can achieve good adhesiveness (such as strength and cohesive fracture properties), good adhesion moisture resistance, good curing characteristics (such as pot life), and the like.

### (Reactive Terminated Polydiene (B1))

The curing agent (B) in the present disclosure comprises a reactive terminated polydiene (B1). The reactive terminated polydiene (B1) has a terminal reactive group reactive with an epoxy group.

The reactive terminated polydiene (B1) may be liquid or solid, and is preferably a liquid or a paste at room temperature (so-called liquid rubber).

The reactive terminated polydiene (B1) is a homopolymer or a copolymer of a diene. Examples of a constituent monomer of the reactive terminated polydiene (B1) include butadiene, isoprene, styrene, acrylonitrile, chloroprene, an acrylic monomer, and a vinyl monomer. Examples of the reactive terminated polydiene (B1) include polyisoprene, polybutadiene, polystyrene-butadiene, polychloroprene, polybutadiene-acrylonitrile, and polyisobutylene, and the reactive terminated polydiene (B1) preferably has an acrylonitrile unit.

The terminal reactive group may be, for example, at least one selected from the group consisting of a hydroxy group, a carboxy group, and an amino group (which may be a primary amino group or a secondary amino group), and is preferably an amino group.

The terminal reactive group may be present at one terminal or more than one terminal in the molecule, and is preferably present at more than one terminal. The number of terminal reactive groups may be 1 or more, 2 or more, or 3 or more on average per molecule, and is preferably more than 1. The number of terminal reactive groups may be 3.5 or less, 2.5 or less, or 1.5 or less on average per molecule.

The weight average molecular weight of the reactive terminated polydiene (B1) may be 1,000 or more, 3,000 or more, 5,000 or more, 7,000 or more, or 10,000 or more. The weight average molecular weight of the reactive terminated polydiene (B1) may be 100,000 or less, 70,000 or less, 50,000 or less, 30,000 or less, or 10,000 or less.

The active hydrogen equivalent of the reactive terminated polydiene (B1) may be 100 or more, 300 or more, 500 or more, 750 or more, or 850 or more, and is preferably 500 or more. The active hydrogen equivalent of the reactive terminated polydiene (B1) may be 5,000 or less, 3,000 or less, 2,000 or less, 1,000 or less, or 500 or less, and is preferably 2,000 or less. When the active hydrogen equivalent is within the above range, good adhesiveness (such as strength and cohesive fracture properties), good adhesion moisture resistance, good curing characteristics (such as pot life), and the like can be achieved.

Examples of commercially available products of the reactive terminated polydiene (B1) include “ATBN” and “CTBN” series of ECVC THERMOSET SPECIALITIES, for example, ATBN 1300X16.

### (Reactive Polyamine (B2))

The curing agent (B) in the present disclosure comprises a reactive polyamine (B2). The reactive polyamine (B2) is an amine compound having two or more of at least one selected from primary and secondary amino groups. The reactive polyamine (B2) does not comprise the reactive terminated polydiene (B1) and the amidine (B3).

The active hydrogen equivalent of the reactive polyamine (B2) may be 10 or more, 300 or more, 500 or more, 750 or more, or 850 or more. The active hydrogen equivalent of the reactive polyamine (B2) may be 5,000 or less, 3,000 or less, 2,000 or less, or 1,000 or less.

The reactive polyamine (B2) may comprise at least one selected from a polyether polyamine (B2-1) and a non-polyether-modified polyamine (B2-2), and preferably comprises both a polyether polyamine (B2-1) and a non-polyether-modified polyamine (B2-2). This can achieve good adhesiveness (such as strength and cohesive fracture properties), good adhesion moisture resistance, good curing characteristics (such as pot life), and the like.

### Polyether Polyamine (B2-1)

The reactive polyamine (B2) may comprise a polyether polyamine (B2-1). The polyether polyamine (B2-1) is a polyamine containing a polyether skeleton.

The polyether skeleton may be a polyoxyalkylene skeleton, and the polyoxyalkylene skeleton may be a skeleton represented by general formula (1):

—[R¹—O-]ₚ—

wherein R¹ represents an alkylene group, and p represents an integer.

R¹ may be a linear, branched, or cyclic alkylene group, and is preferably a linear or branched alkylene group. The number of carbon atoms in R¹ may be 1 to 10, and is preferably 2 to 5. Examples of R¹ include an ethylene group, a propylene group, a trimethylene group, a n-butylene group (tetramethylene group), an i-butylene group, a s-butylene group, and a t-butylene group, and among them, an ethylene group, a propylene group, and tetramethylene are preferable. In the polyoxyalkylene skeleton, R¹'s may be identical or different.

p may be 3 or more, and is, for example, 5 or more, or 10 or more. p may be 100 or less, 75 or less, or 50 or less.

The weight average molecular weight of the polyether polyamine (B2-1) may be 100 or more, 500 or more, 1,000 or more, 3,000 or more, 5,000 or more, 7,000 or more, or 10,000 or more. The weight average molecular weight of the polyether polyamine (B2-1) may be 100,000 or less, 50,000 or less, 30,000 or less, 10,000 or less, 5,000 or less, 3,000 or less, 2,000 or less, 1,000 or less, or 500 or less, and is preferably 3,000 or less or 1,000 or less, and particularly 500 or less.

The active hydrogen equivalent of the polyether polyamine (B2-1) may be 10 or more, 100 or more, 300 or more, 500 or more, 750 or more, or 850 or more. The active hydrogen equivalent of the polyether polyamine (B2-1) may be 5,000 or less, 3,000 or less, 2,000 or less, or 1,000 or less.

Examples of the polyetheramine include polyethertriamine, polyetherdiamine, polyoxypropylenediamine, polytetrahydrofuranediamine, and polyoxypropylenetriamine.

Examples of commercially available products of the polyether polyamine (B2-1) include “Jeffamine” series manufactured by Huntsman Corporation.

### Non-Polyether-Modified Polyamine (B2-2)

The reactive polyamine (B2) may comprise a non-polyether-modified polyamine (B2-2).

The non-polyether-modified polyamine (B2-2) is a compound having no polyether skeleton, and is a compound obtained by reaction of an amine compound with another compound and having adjusted curing characteristics and the like.

Examples of the non-polyether-modified polyamine (B2-2) include an adduct of an amine compound and an epoxy compound, an adduct of an amine compound and an isocyanate compound, a dehydrated condensate of an amine compound and a carboxylic acid, a Michael adduct of an amine compound, a Mannich reaction product of an amine compound, a condensate of an amine compound and urea, and a condensate of an amine compound and a ketone. Here, examples of the amine compound include another polyamine (B2-3). The non-polyether-modified polyamine (B2-2) may be used alone, or two or more thereof may be used in combination.

The non-polyether-modified polyamine (B2-2) is preferably a liquid at room temperature. At least one of the non-polyether-modified polyamines (B2-2) may be a liquid, and all of them may be a liquid.

The weight average molecular weight of the non-polyether-modified polyamine (B2-2) may be 100 or more, 500 or more, 1,000 or more, 3,000 or more, 5,000 or more, 7,000 or more, or 10,000 or more. The weight average molecular weight of the non-polyether-modified polyamine (B2-2) may be 100,000 or less, 50,000 or less, 30,000 or less, 10,000 or less, 5,000 or less, 3,000 or less, 2,000 or less, 1,000 or less, or 500 or less.

The active hydrogen equivalent of the non-polyether-modified polyamine (B2-2) may be 10 or more, 30 or more, 50 or more, 100 or more, 300 or more, or 500 or more. The active hydrogen equivalent of the non-polyether-modified polyamine (B2-2) may be 3,000 or less, 2,000 or less. 1,000 or less, 500 or less, 300 or less, or 100 or less.

When the non-polyether-modified polyamine (B2-2) is an adduct of a polyamine compound and an epoxy compound, a compound exemplified for the epoxy resin (A) as the epoxy compound may be used.

When the non-polyether-modified polyamine (B2-2) is an adduct of a polyamine compound and an isocyanate compound, examples of the isocyanate compound include aromatic diisocyanates such as 2,4-tolylene diisocyanate, 2,6-tolylene diisocyanate, diphenylmethane-4,4′-diisocyanate, phenylene diisocyanate, xylylene diisocyanate, tetramethylxylylene diisocyanate, 1,5-naphthylene diisocyanate, 1,5-tetrahydronaphthalene diisocyanate, 3,3′-dimethyldiphenyl-4,4′-diisocyanate, dianisidine diisocyanate, and tetramethylxylylene diisocyanate; alicyclic diisocyanates such as isophorone diisocyanate, dicyclohexylmethane-4,4′-diisocyanate, trans-1,4-cyclohexyl diisocyanate, and norbornene diisocyanate; aliphatic diisocyanates such as tetramethylene diisocyanate, 1,6-hexamethylene diisocyanate, 2,2,4 and/or (2,4,4)-trimethylhexamethylene diisocyanate, and lysine diisocyanate; isocyanurate trimers, biuret trimers, trimethylolpropane adducts, and the like of the exemplified diisocyanates; triphenylmethane triisocyanate, 1-methylbenzol-2,4,6-triisocyanate, and dimethyltriphenylmethane tetraisocyanate. These isocyanate compounds may be used in a carbodiimide-modified, isocyanurate-modified, or biuret-modified form, or the like, or may be used in the form of a blocked isocyanate blocked with various blocking agents. These may be used alone or two or more of these may be used in combination.

Examples of commercially available products of the non-polyether-modified polyamine (B2-2) include “Hardener” series (for example, Hardener EH-6019, Hardener EH-451N, and the like) manufactured by ADEKA CORPORATION, “Fujicure” series manufactured by T&K TOKA Corporation, “DAITOCURAR” series (for example, DAITOCURAR B-2413) manufactured by Daito Sangyo Co., Ltd., “LUCKAMIDE” series (for example, WH-614, F4, WH-650) manufactured by DIC Corporation, and “ANCAMINE” series (for example, “ANCAMINE 2143” manufactured by Evonik Industries AG. The product of the non-polyether-modified polyamine (B2-2) may be usually obtained by modifying an amine compound with an amine-reactive compound (for example, epoxy), and may be a mixture of the non-polyether-modified polyamine (B2-2) and another amine compound (for example, another polyamine (B2-3)).

### Another Polyamine (B2-3)

The reactive polyamine (B2) may comprise another polyamine (B2-3) in addition to the polyether polyamine (B2-1) and the non-polyether-modified polyamine (B2-2). Examples of the another polyamine (B2-3) include alkylenediamines such as ethylenediamine, 1,2-diaminopropane, 1,3-diaminopropane, 1,3-diaminobutane, 1,4-diaminobutane, and hexamethylenediamine; polyalkylpolyamines such as diethylenetriamine, triethylenetriamine, and tetraethylenepentamine; polyether polyamines such as polyether triamine, polyether diamine, polyoxypropylene diamine, polytetrahydrofuran diamine, and polyoxypropylene triamine; alicyclic polyamines such as 1,4-diaminocyclohexane, 1,3-diaminocyclohexane, 1,3-diaminomethylcyclohexane, 1,2-diaminocyclohexane, 1,4-diamino-3,6-diethylcyclohexane, 4,4′-diaminodicyclohexylmethane, 1,4-1,3-bis(aminomethyl)cyclohexane, bis(aminomethyl)cyclohexane, aminocyclohexyl) sulfone, 4,4′-diaminodicyclohexyl ether, 2,2′-dimethyl-4,4′-4,4′-diaminodicyclohexylpropane, bis(4-diaminodicyclohexylmethane, isophoronediamine, and norbornenediamine; aromatic polyamines such as m-xylylenediamine, diaminodiphenylmethane, diaminodiphenylsulfone, diethyltoluenediamine, 1-methyl-3,5-diethyl-2,4-diaminobenzene, 1-methyl-3,5-diethyl-2,6-diaminobenzene, 1,3,5-triethyl-2,6-diaminobenzene, 3,3′-diethyl-4,4′-diaminodiphenylmethane, and 3,5,3′,5′-tetramethyl-4,4′-diaminodiphenylmethane; guanamines such as benzoguanamine and acetoguanamine; imidazoles such as 2-methylimidazole, 2-ethyl-4-methylimidazole, 2-isopropylimidazole, 2-undecylimidazole, 2-heptadecylimidazole, 2-phenylimidazole, 2-phenyl-4-methylimidazole, and 2-aminopropylimidazole: dihydrazides such as oxalic acid dihydrazide, malonic acid dihydrazide, succinic acid dihydrazide, glutaric acid dihydrazide, adipic acid dihydrazide, suberic acid dihydrazide, azelaic acid dihydrazide, sebacic acid dihydrazide, and phthalic acid dihydrazide; N,N-dimethylaminoethylarmine, N,N-diethylaminoethylamine, N,N-diisopropylaminoethylamine, N,N-diallylaminoethylamine, N,N-benzylmethylaminoethylamine, N,N-dibenzylamninoetihylamine, N,N-cyclohexylmethylaminoethylamine, N,N-dicyclohexylaminoethylamine, N-(2-aminoethyl)pyrrolidine, N-(2-aminoethyl)piperidine, N-(2-aminoethyl)morpholine, N-(2-amrinoethyl)piperazine, N-(2-aminoethyl)-N′-methylpiperazine, N,N-dimethylaninopropylamire, N,N-diethylaminopropylamine, N,N-diisopropylam-iopropylamine, N,N-diallylaminopropylamine, N,N-benzylmethylaminopropylarnine, N,N-dibenzylamiinopropylamine, N,N-cyclohexylmethylaminopropylamine, N,N-dicyclohexylaminopropylamine, N-(3-aminopropyI)pyrrolidine, N-(3-aminopropyl)piperidine, N-(3-aminopropyl)morpholine, N-(3-arinopropyl)piperazine, N-(3-aminopropyl)-N′-methylpiperidine, 4-(N,N-dimethylamino)benzyiamine, 4-(N,N-diethylamino)benzylamine, 4-(N,N-diisopropylaiino)benzylamine, N,N,-dimnethylisophoronedianine, N,N-dimethylbisaminocyclohexane, N,N,N′-trimethylethylenediamine, N′-ethyl-N,N-dimethylethylenediamine, N,N,N′-trimethylethylenediamine, N′-ethyl-N,N-dimethlpropanediamine, N′-ethyl-N,N-dibenzvlaminopropylamine; N,N-(bisam-inopropyl)-N-methylamine, N,N-bisaminopropylethylamine, N,N-bisaminopropylpropylpropylamine, N,N-bisaminopropylbutylamine, N,N-bisaminopropylpentylamine, N,N-bisaminopropylhexylamine, N,N-bisaminopropyl-2-ethylhexylamine, N,N-bisaminopropylcyclohexylamine, N,N-bisaminopropylbenzylamine, N,N-bisaminopropylallylamine, bis[3-(N,N-dimethylaminopropyl)]amine, bis[3-(N,N-diethylaminopropyl)]amine, bis[3-(N,N-diisopropylaminopropyi)]amine, and bis[3-(N,N-dibutylaminopropyl)]amine. These may be used alone or two or more of these may be used in combination.

### (Amidine (B3))

The curing agent (B) in the present disclosure comprises an amidine (B3). In general, an amidine is a compound having a structure represented by R—C(═NR¹)—NR²R³ (wherein one or more of R¹, R², and R³ may be bonded to each other to form a ring), and the amidine (B3) is an amidine or a salt thereof.

The amidine (B3) may be aliphatic or aromatic, and is particularly cycloaliphatic.

R¹, R², and R³ are each independently a hydrogen atom or an organic group, and preferably an organic group. Examples of the organic group particularly include a hydrocarbon group.

The amidine (B3) is preferably heterocyclic, and at least one or all nitrogen atoms forming the amidine may be ring atoms.

The amidine (B3) may be bicyclic or polycyclic, and is preferably bicyclic.

It is preferable that the amidine (B3) has no primary amino group and no secondary amino group and has no active hydrogen of an amine, and all nitrogen atoms may be tertiary amines.

The amidine (B3) may be a salt, and is preferably an organic acid salt such as an octylate, a phenol salt, a p-toluenesulfonate, a formate, a phthalate, an orthophthalate, a tetraphenylborate, a trimellitate, a terephthalate, or a cyanurate.

The molecular weight of the amidine (B3) may be 50 or more, 100 or more, or 300 or more. The molecular weight of the amidine (B3) may be 2,000 or less, 1,000 or less, or 500 or less.

Examples of the amidine (B3) include various derivatives such as diazabicycloundecene (DBU), diazabicyclononene (DBN), imidazole, pyrimidine, and purine, or salts thereof, and a preferred example thereof is a phenol salt of diazabicycloundecene or a phenol salt of diazabicyclononene.

Examples of commercially available products of the amidine (B3) include “DBU”, “U-CAT SA 102”, “U-CAT SA 1”, “U-CAT SA603”, and “DBN” manufactured by San-Apro Ltd.

### (Non-Amidine Tertiary Amine (B4))

The curing agent (B) in the present disclosure may comprise a non-amidine tertiary amine (B4). The non-amidine tertiary amine (B4) is a non-amidine, has no primary amino group and no secondary amino group, and has no active hydrogen of an amine. Incorporation of the non-amidine tertiary amine (B4) can achieve good adhesiveness (such as strength and cohesive fracture properties), good adhesion moisture resistance, good curing characteristics (such as pot life), and the like.

The non-amidine tertiary amine (B4) may be aromatic or aliphatic and may have a cyclic group. The tertiary amine (B4) may have a hydroxy group, and the hydroxy group may be a phenolic hydroxy group or a non-phenolic hydroxy group.

The molecular weight of the non-amidine tertiary amine (B4) may be 50 or more, 100 or more, or 300 or more. The molecular weight of the non-amidine tertiary amine (B4) may be 2,000 or less, 1,000 or less, or 500 or less.

Examples of the non-amidine tertiary amine (B4) include N-ethylmorpholine, isopropylmorpholine, N-butylmorpholine, methoxyethylmorpholine, hydroxyethylmorpholine, 2,2′-dimorpholinodiethyl ether, N,N′-dimorpholinoethane, methyldiethanolamine, N,N-dimethylcyclohexylamine, methyldicyclohexylamine, N,N,N′-trimethyl-N′-(2-hydroxyethyl)bis(2-aminoethyl) ether, bis-(2-dimethylaminoethyl) ether, N,N′-dimethylpiperazine, 1,3,5-tris (3-(dimethylamino) propyl)-hexahydro-s-triazine, and 2,4,6-tris(dimethylaminomethyl) phenol.

### (Amino Group-Containing Silane Coupling Agent (B5))

The curing agent (B) in the present disclosure may comprise an amino group-containing silane coupling agent (B5). Incorporation of the amino group-containing silane coupling agent (B5) can achieve good adhesiveness (such as strength and cohesive fracture properties), good adhesion moisture resistance, good curing characteristics (such as pot life), and the like.

The silane coupling agent is an organic silicon compound having at least two functional groups having different reactivities in one molecule, and generally has a reactive silyl group and an organic reactive group. The silane coupling agent may have one reactive silyl group or two or more (for example, two) reactive silyl groups in the molecule. The amino group-containing silane coupling agent (B5) has at least one amino group (a primary amino group, a secondary amino group, or a tertiary amino group), and preferably has a primary amino group or a secondary amino group.

The amino group-containing silane coupling agent (BS) in the present disclosure is aromatic or aliphatic, and may be a monosilane type coupling agent represented by formula (1) and/or a bissilane type coupling agent represented by formula (2).

### Monosilane Type Coupling Agent

The amino group-containing silane coupling agent (B5) may be a monosilane type coupling agent represented by formula (1):

X-Si-R^{a}ₙ(R^{b})₃₋ₙ (1)
wherein X is a reactive group,
R^{a} is each independently a hydrocarbon group,
R^{b} is each independently a reactive group, and
n is 0, 1, or 2.

X is a reactive group that can be chemically bonded to an organic material. X is an amino group-containing group (a primary amino group-containing group, a secondary amino group-containing group, or a tertiary amino group-containing group), and preferably has a primary amino group-containing group or a secondary amino group-containing group. X may be an aliphatic group or an aromatic group, and is preferably an aliphatic group. The number of carbon atoms in X may be 15 or less, 12 or less, 10 or less, 8 or less, 6 or less, or 4 or less, and is preferably 10 or less. The number of carbon atoms in X may be 1 or more, 2 or more, 3 or more, 4 or more, or 5 or more, and is preferably 2 or more.

R^{a} is a hydrocarbon group, and is, for example, an alkyl group. The number of carbon atoms in R^{a} may be 1 or more, 2 or more, 3 or more, 4 or more, or 5 or more. The number of carbon atoms in R^{a} may be 15 or less, 12 or less, 10 or less, 8 or less, or 6 or less, and is preferably 10 or less.

R^{b} is a reactive group that can be chemically bonded to an inorganic material such as a glass or a metal. R^{b} is an alkoxy group, (a methoxy group, an ethoxy group, a propoxy group, or a butoxy group). The number of carbon atoms in R^{b} may be 1 or more, 2 or more, 3 or more, 4 or more, or 5 or more. The number of carbon atoms in R^{b} may be 15 or less, 12 or less, 10 or less, 8 or less, 6 or less, or 4 or less.

n is 0, 1, or 2, and is preferably 0 or 1.

### Bissilane Type Coupling Agent

The amino group-containing silane coupling agent (B5) may be a bissilane type coupling agent represented by formula (2):

R^{a′}ₙ(R^{b′})₃₋ₙSi-X′-Si-R^{a′}ₘ(R^{b′})₃₋ₘ (2)
wherein X′ is a reactive group,

R^{a}'s are each independently a hydrocarbon group,
R^{b}'s are each independently a reactive group, and
ms are each independently 0, 1, or 2.

X is a reactive group that can be chemically bonded to an organic material. X is an amino group-containing group (a primary amino group-containing group, a secondary amino group-containing group, or a tertiary amino group-containing group), and preferably has a primary amino group-containing group or a secondary amino group-containing group. X may be an aliphatic group or an aromatic group, and is preferably an aliphatic group. The number of carbon atoms in X may be 15 or less, 12 or less, 10 or less, 8 or less, 6 or less, or 4 or less, and is preferably 10 or less. The number of carbon atoms in X may be 1 or more, 2 or more, 3 or more, 4 or more, or 5 or more, and is preferably 2 or more.

R^{a′} is a hydrocarbon group, and is, for example, an alkyl group. The number of carbon atoms in R^{a′} may be 1 or more, 2 or more, 3 or more, 4 or more, or 5 or more. The number of carbon atoms in R^{a′} may be 15 or less, 12 or less, 10 or less, 8 or less, or 6 or less, and is preferably 10 or less.

R^{b} is a reactive group that can be chemically bonded to an inorganic material such as a glass or a metal. R^{b′} is an alkoxy group, (a methoxy group, an ethoxy group, a propoxy group, or a butoxy group). The number of carbon atoms in R^{b′} may be 1 or more, 2 or more, 3 or more, 4 or more, or 5 or more. The number of carbon atoms in R^{b} may be 15 or less, 12 or less, 10 or less, 8 or less, 6 or less, or 4 or less.

m is 0, 1, or 2, and is preferably 0 or 1.

The amino group-containing silane coupling agent (B5) may have an OH group (hydroxy group) or an NH₂ group (amino group). The OH group does not include an OH group (silanolic hydroxy) generated by hydrolysis of an alkoxy group.

The molecular weight of the amino group-containing silane coupling agent (B5) may be 50 or more, 100 or more, or 300 or more. The molecular weight of the amino group-containing silane coupling agent (B5) may be 2,000 or less, 1,000 or less, or 500 or less.

The active hydrogen equivalent of the amino group-containing silane coupling agent (B5) may be 10 or more, 100 or more, 300 or more, 500 or more, 750 or more, or 850 or more. The active hydrogen equivalent of the amino group-containing silane coupling agent (B5) may be 5,000 or less, 3,000 or less, 2,000 or less, or 1,000 or less.

Examples of the amino group-containing silane coupling agent (B5) having a primary amino group include 3-aminopropyltriethoxysilane and 3-aminopropyltrimethoxysilane.

Examples of the amino group-containing silane coupling agent (B5) having a secondary amino group include, as the secondary amino group-containing silane coupling agent, N-alkyl-aminoalkylalkoxysilane [for example, N-C₁₋₁₀ alkyl-amino C₁₋₄ alkyl tri-C₁₋₄ alkoxysilane such as N-ethyl-2-aminoethyltrimethoxysilane and N-ethyl-3-aminopropyltrimethoxysilane, and the like], N-cycloalkyl-aminoalkylalkoxysilane [for example, N-C₃₋₁₀ cycloalkyl-amino C₁₋₄ alkyl tri-C₁₋₄ alkoxysilane such as N-cyclohexyl-2-aminoethyltrimethoxysilane and N-cyclohexyl-3-aminopropyltrimethoxysilane, and the like], and N-aryl-aminoalkylalkoxysilane [for example, N-aryl-amino C₁₋₄ alkyl C₁₋₄ alkyl di-C₁₄ alkoxysilane such as N-phenyl-2-aminoethylmethyldimethoxysilane, N-phenyl-2-aminoethylmethyldiethoxysilane, N-phenyl-3-aminopropylmethyldimethoxysilane, and N-phenyl-3-aminopropylmethyldiethoxysilane; N-aryl-amino C₁₋₄ alkyl C₁₋₄ alkyl di-C₁₄ alkoxysilane such as N-phenyl-2-aminoethylmethyldimethoxysilane, N-phenyl-2-aminoethylmethyldiethoxysilane, N-phenyl-3-aminopropylmethyldimethoxysilane, and N-phenyl-3-aminopropylmethyldiethoxysilane; N-aryl-amino C₁₋₄ alkyl tri-C₁₄ alkoxysilane such as N-phenyl-2-aminoethyltrimethoxysilane, N-phenyl-2-aminoethyltriethoxysilane, N-phenyl-3-aminopropyltrimethoxysilane, and N-phenyl-3-aminopropyltriethoxysilane, and the like]. These may be used alone or two or more of these may be used in combination.

Examples of the tertiary amino group-containing silane coupling agent include C₁₋₄ alkyl di-C₁₋₄ alkoxysilyl-N-(linear or branched C₁₋₁₂ alkylidene)-C₁₋₄ alkylamine such as 3-methyldimethoxysilyl-N-propylidene-propylamine, 3-methyldiethoxysilyl-N-propylidene-propylamine, 3-methyldimethoxysilyl-N-butylidene-propylamine, 3-methyldiethoxysilyl-N-butylidene-propylamine, 3-methyldimethoxysilyl-N-(1-methylbutylidene)-propylamine, 3-methyldiethoxysilyl-N-(1-methylbutylidene)-propylamine, 3-methyldimethoxysilyl-N-(1-ethylbutylidene)-propylamine, 3-methyldiethoxysilyl-N-(1-ethylbutylidene)-propylamine, 3-methyldimethoxysilyl-N-(1,3-dimethylbutylidene)-propylamine, 3-methyldiethoxysilyl-N-(1,3-dimethylbutylidene)-propylamine, 3-methyldimethoxysilyl-N-(1-ethyl-3-methylbutylidene)-propylamine, and 3-methyldiethoxysilyl-N-(1-ethyl-3-methylbutylidene)-propylamine; and tri-C₁₄ alkoxysilyl-N-(linear or branched C₁₋₁₂ alkylidene)-C₁₋₄ alkylamine such as 3-trimethoxysilyl-N-propylidene-propylamine, 3-triethoxysilyl-N-propylidene-propylamine, 3-trimethoxysilyl-N-butylidene-propylamine, 3-triethoxysilyl-N-butylidene-propylamine, 3-trimethoxysilyl-N-(1-methylbutylidene)-propylamine, 3-triethoxysilyl-N-(1-methylbutylidene)-propylamine, 3-trimethoxysilyl-N-(1-ethylbutylidene)-propylamine, 3-triethoxysilyl-N-(1-ethylbutylidene)-propylamine, 3-trimethoxysilyl-N-(1,3-dimethylbutylidene)-propylamine, 3-triethoxysilyl-N-(1,3-dimethylbutylidene)-propylamine, 3-trimethoxysilyl-N-(1-ethyl-3-methylbutylidene)-propylamine, and 3-triethoxysilyl-N-(1-ethyl-3-methylbutylidene)-propylamine. These may be used alone or two or more of these may be used in combination.

### [Long-Chain Hydrocarbon Group-Containing Phenol (C)]

The adhesive in the present disclosure may comprise a long-chain hydrocarbon group-containing phenol (C). The long-chain hydrocarbon group-containing phenol is a compound in which one or more (for example, one or two) benzene ring hydrogen atoms of a phenol are substituted with a long-chain hydrocarbon group. Incorporation of the long-chain hydrocarbon group-containing phenol (C) can achieve good adhesiveness (such as strength and cohesive fracture properties), good adhesion moisture resistance, good curing characteristics (such as pot life), and the like.

The number of carbon atoms in the long-chain hydrocarbon group may be 10 or more, 12 or more, 15 or more, 17 or more, 20 or more, 25 or more, or 30 or more. The number of carbon atoms in the long-chain hydrocarbon group may be 50 or less, 45 or less, 40 or less, 35 or less, 30 or less, 25 or less, 20 or less, or 18 or less.

The long chain hydrocarbon group may be saturated aliphatic or unsaturated aliphatic. When the long-chain hydrocarbon group is unsaturated aliphatic, it is contained in the long-chain hydrocarbon group. The number of unsaturated bonds may be one, two, or three. Examples of the long-chain hydrocarbon group having one unsaturated bond include an 8-pentadecaenyl group. Examples of the long-chain hydrocarbon group having two unsaturated bonds include a 7,10-pentadecadienyl group and an 8,11-pentadecadienyl group. Examples of the long-chain hydrocarbon group having three unsaturated bonds include an 8,11,14-pentadecatrienyl group. These may be used alone or two or more of these may be used in combination.

Examples of the long-chain hydrocarbon group-containing phenol (C) include components of cashew nut oil (such as cardanol, 2-methylcardol, 2-methylcardol, and anacardic acid), decylphenol, and dodecylphenol.

Examples of commercially available products of the long-chain hydrocarbon group-containing phenol (C) include NX series of Cardolite Corporation.

### [Rubber Particles (D)]

The adhesive in the present disclosure may comprise rubber particles (D). Incorporation of the rubber particles (D) can achieve good adhesiveness (such as strength and cohesive fracture properties), good adhesion moisture resistance, good curing characteristics (such as pot life), and the like.

The rubber particles (D) may not have reactivity with an epoxy group. In the case of a two-component type or multi-component type adhesive, the rubber particles (D) may be added to a part on the main agent side containing the epoxy resin, or may be added to a part on the curing agent side.

The average particle size of the rubber particles may be 50 nm or more, 100 nm or more, 250 nm or more, 500 nm or more, 1 μm or more, or 3 μm or more. The average particle size of the rubber particles may be 1 mm or less, 500 μm or less, 100 μm or less, 10 μm or less, or 1 μm or less.

Examples of a component forming the rubber particles (D) include isoprene rubber, butadiene rubber, styrene-butadiene rubber, chloroprene rubber, nitrile rubber, polyisobutylene, ethylene propylene rubber, chlorosulfonated polyethylene, acrylic rubber, fluororubber, epichlorohydrin rubber, urethane rubber, and silicone rubber. These may be used alone or two or more of these may be used in combination.

The rubber particles (D) may be core-shell type rubber particles. The core-shell type rubber particles are rubber particles having a core layer and a shell layer, and examples of the core-shell type rubber particles include those having a two-layer structure in which the shell layer as an outer layer is made of a hard polymer and the core layer as an inner layer is made of a rubber-like polymer, or those having a three-layer structure in which the shell layer as an outer layer is made of a hard polymer, the intermediate layer is made of a rubber-like polymer, and the core layer is made of a hard polymer. The hard polymer may be made of, for example, a polymer of methyl methacrylate, a polymer of methyl acrylate, a polymer of styrene, or the like. The rubber-like polymer layer may be made of the above-mentioned rubber component, for example, a butyl acrylate polymer (butyl rubber), silicone rubber, polybutadiene, or the like. This core-shell structure can be formed naturally as a result of separation of a block copolymer or as a result of emulsion polymerization or suspension polymerization and a subsequent polymerization reaction operation as grafting. The rubber particles (D) may be used alone, or two or more thereof may be used in combination.

Examples of commercially available products of the core-shell type rubber particles include MBS polymers such as “Clearstrength” manufactured by Atofina, “Paraloid” manufactured by Rohm and Haas Company, and “F-351” manufactured by Zeon Corporation; “GENIOPERL M23A” manufactured by Wacker Chemie AG with a polysiloxane core and an acrylate shell; radiation-crosslinked rubber particles of NEO series manufactured by Eliokem; “Nanoprene” manufactured by Lanxess AG; “Paraloid EXL” manufactured by Rohm and Haas Company; “Albidur” and the like manufactured by Nanoresins AG, “Kane Ace” series (for example, Kane Ace 150 and 120) manufactured by KANEKA CORPORATION, and “ZEFIAC” series manufactured by Aica Kogyo Company, Limited. The core-shell type rubber particles include core-shell type rubber particles dispersed in the epoxy resin in advance, and may be dispersed in the epoxy resin in advance usually at a concentration of about 10% to 50%.

### [Filler (E)]

The adhesive in the present disclosure may comprise a filler (E). The adhesiveness, sagging property, specific gravity, and the like can be adjusted by adding the filler. Examples of the filler (E) include heavy calcium carbonate, surface-untreated calcium carbonate, surface-treated calcium carbonate (for example, fatty acid-treated calcium carbonate), fumed silica, hydrophobic silica, precipitated silica, carbon black, talc, mica, clay, glass beads, balloons such as microballoons, shirasu balloons, glass balloons, silica balloons, plastic balloons, and organic powder-coated plastic balloons, plastic particles, inorganic fibers such as glass fibers, and metal fibers, organic fibers such as polyethylene fibers and polypropylene fibers, aluminum borate, silicon carbide, silicon nitride, potassium titanate, graphite, needle crystalline fillers such as needle crystalline calcium carbonate, magnesium borate, titanium diborate, chrysotile, and wollastonite, aluminum flakes, aluminum powder, and iron powder. These may be used alone or two or more of these may be used in combination.

### [Other Components (F)]

The adhesive in the present disclosure may comprise other components (F) in addition to the above components. Examples of the other components (F) include a colorant, an organic solvent (such as methanol, ethanol, isopropyl alcohol, butanol, acetone, methyl ethyl ketone, ligroin, ethyl acetate, tetrahydrofuran, n-hexane, heptane, or an isoparaffin-based high-boiling solvent), an adhesion agent (a silane coupling agent such as vinyltrimethoxysilane, vinyltriethoxysilane, aminosilane, mercaptosilane, or epoxysilane, an epoxy compound such as glycidyl ether having a polyoxyalkylene skeleton, or the like), an anti-aging agent (such as a hindered phenol, a mercaptan, a sulfide, a dithiocarboxylate, a thiourea, a thiophosphate, or a thioaldehyde), a moisture retention agent (such as water or a hydrate of an inorganic salt), an ultraviolet absorber/light stabilizer (such as a benzotriazole or a hindered amine), an antioxidant (such as a hindered phenol), a thixotropic agent (such as colloidal silica, organic bentonite, a fatty acid amide, or hydrogenated castor oil), and polymer components other than the above components (a thermoplastic elastomer, natural rubber (NR), acrylonitrile-butadiene rubber (NBR), an acrylic polymer, a urethane polymer, and a silicone polymer). These may be used alone or two or more of these may be used in combination.

### [Composition of Adhesive]

The composition of the adhesive may be adjusted so that the ratio of the number of epoxy groups to the number of active hydrogen (particularly, the number of active hydrogen of an amine) in the adhesive is 0.5 or more, 0.6 or more, 0.7 or more, 0.8 or more, 0.9 or more, 0.95 or more, 1.0 or more, or 1.1 or more, and preferably 0.95 or more, or 1.0 or more. The composition of the adhesive may be adjusted so that the ratio of the number of epoxy groups to the number of active hydrogen (particularly, the number of active hydrogen of an amine) in the adhesive is 2.0 or less, 1.8 or less, 1.6 or less, 1.4 or less, 1.3 or less, 1.2 or less, or 1.1 or less, and preferably 1.35 or less, or 1.2 or less.

### (Amount of Epoxy Resin (A))

The amount of the epoxy resin (A) may be 10 wt % or more, 15 wt % or more, 20 wt % or more, 25 wt % or more, 30 wt % or more, or 35 wt % or more, preferably 20 wt % or more, and more preferably 30 wt % or more in the adhesive. The amount of the epoxy resin (A) may be 60 wt % or less, 55 wt % or less, 50 wt % or less, 45 wt % or less, 40 wt % or less, or 35 wt % or less, preferably 55 wt % or less, and more preferably 45 wt % or less in the adhesive.

### Amount of Bisphenol Type Epoxy Resin

The amount of the bisphenol type epoxy resin may be 5 wt % or more, 10 wt % or more, 20 wt % or more, 30 wt % or more, 40 wt % or more, 50 wt % or more, 60 wt % or more, or 70 wt % or more, and is preferably 20 wt % or more, more preferably 30 wt % or more, and still more preferably 40 wt % or more in the epoxy resin (A). The amount of the bisphenol type epoxy resin may be 95 wt % or less, 85 wt % or less, 75 wt % or less, 65 wt % or less, 55 wt % or less, 45 wt % or less, or 35 wt % or less in the epoxy resin (A).

### Amount of Glycidyl Ester Type Epoxy Resin

The amount of the glycidyl ester type epoxy resin may be 1 wt % or more, 5 wt % or more, 10 wt % or more, 15 wt % or more, 20 wt % or more, 25 wt % or more, 30 wt % or more, 35 wt % or more, or 40 wt % or more, and is preferably 10 wt % or more in the epoxy resin (A). The amount of the glycidyl ester type epoxy resin may be 50 wt % or less, 40 wt % or less, 30 wt % or less, 20 wt % or less, or 10 wt % or less in the epoxy resin (A).

### (Amount of Curing Agent (B))

The amount of the curing agent (B) may be 1 wt % or more, 5 wt % or more, 10 wt % or more, 15 wt % or more, 20 wt % or more, 25 wt % or more, 30 wt % or more, 35 wt % or more, or 40 wt % or more, and is preferably 10 wt % or more in the adhesive. The amount of the curing agent (B) may be 70 wt % or less, 60 wt % or less, 55 wt % or less, 50 wt % or less, 45 wt % or less, 50 wt % or less, 40 wt % or less, 30 wt % or less, 20 wt % or less, or 10 wt % or less in the adhesive.

### Amount of Reactive Terminated Polydiene (B1)

The amount of the reactive terminated polydiene (B1) may be 1 wt % or more, 3 wt % or more, 5 wt % or more, 7 wt % or more, 9 wt % or more, or 10 wt % or more, and is preferably 5 wt % or more in the adhesive. The amount of the reactive terminated polydiene (B1) may be 50 wt % or less, 40 wt % or less, 30 wt % or less, 20 wt % or less, 15 wt % or less, or 10 wt % or less in the adhesive.

### Amount of Reactive Polyamine (B2)

The amount of the reactive polyamine (B2) may be 10 parts by weight or more, 30 parts by weight or more, 50 parts by weight or more, 75 parts by weight or more, 100 parts by weight or more, or 120 parts by weight or more, and is preferably 30 parts by weight or more with respect to 100 parts by weight of the reactive terminated polydiene (B1). The amount of the reactive polyamine (B2) may be 300 parts by weight or less, 250 parts by weight or less, 200 parts by weight or less, 150 parts by weight or less, 125 parts by weight or less, 100 parts by weight or less, or 50 parts by weight or less, and is preferably 125 parts by weight or less with respect to 100 parts by weight of the reactive terminated polydiene (B1).

### Amount of Polyether Polyamine (B2-1)

The amount of the polyether polyamine (B2-1) may be 5 wt % or more, 10 wt % or more, 20 wt % or more, 30 wt % or more, 40 wt % or more, 50 wt % or more, 60 wt % or more, or 70 wt % or more, and is preferably 20 wt % or more, more preferably 30 wt % or more, and still more preferably 40 wt % or more in the reactive polyamine (B2). The amount of the polyether polyamine (B2-1) may be 95 wt % or less, 85 wt % or less, 75 wt % or less, 65 wt % or less, 55 wt % or less, 45 wt % or less, or 35 wt % or less in the reactive polyamine (B2).

### Amount of Non-Polyether-Modified Polyamine (B2-2)

The amount of the non-polyether-modified polyamine (B2-2) may be 5 wt % or more, 10 wt % or more, 20 wt % or more, 30 wt % or more, 40 wt % or more, 50 wt % or more, 60 wt % or more, or 70 wt % or more, and is preferably 20 wt % or more, more preferably 30 wt % or more, and still more preferably 40 wt % or more in the reactive polyamine (B2). The amount of the non-polyether-modified polyamine (B2-2) may be 95 wt % or less, 85 wt % or less, 75 wt % or less, 65 wt % or less, 55 wt % or less, 45 wt % or less, or 35 wt % or less in the reactive polyamine (B2).

### Amount of Amidine (B3)

The amount of the amidine (B3) may be 1 part by weight or more, 3 parts by weight or more, 5 parts by weight or more, 7.5 parts by weight or more, 10 parts by weight or more, or 20 parts by weight or more, and is preferably 3 parts by weight or more with respect to 100 parts by weight of the reactive terminated polydiene (B1). The amount of the amidine (B3) may be 100 parts by weight or less, 80 parts by weight or less, 60 parts by weight or less, 40 parts by weight or less, 20 parts by weight or less, or 15 parts by weight or less, and is preferably 40 parts by weight or less with respect to 100 parts by weight of the reactive terminated polydiene (B1).

### Amount of Non-Amidine Tertiary Amine (B4)

The amount of the non-amidine tertiary amine (B4) may be 1 part by weight or more, 3 parts by weight or more, 5 parts by weight or more, 7.5 parts by weight or more, 10 parts by weight or more, or 20 parts by weight or more, and is preferably 3 parts by weight or more with respect to 100 parts by weight of the reactive terminated polydiene (B1). The amount of the non-amidine tertiary amine (B4) may be 100 parts by weight or less, 80 parts by weight or less, 60 parts by weight or less, 40 parts by weight or less, 20 parts by weight or less, or 15 parts by weight or less, and is preferably 40 parts by weight or less with respect to 100 parts by weight of the reactive terminated polydiene (B1).

### Amount of Amino Group-Containing Silane Coupling Agent (B5)

The amount of the amino group-containing silane coupling agent (B5) may be 1 part by weight or more, 3 parts by weight or more, 5 parts by weight or more, 7.5 parts by weight or more, 10 parts by weight or more, or 20 parts by weight or more, and is preferably 3 parts by weight or more with respect to 100 parts by weight of the reactive terminated polydiene (B1). The amount of the amino group-containing silane coupling agent (B5) may be 100 parts by weight or less, 80 parts by weight or less, 60 parts by weight or less, 40 parts by weight or less, 20 parts by weight or less, or 15 parts by weight or less, and is preferably 40 parts by weight or less with respect to 100 parts by weight of the reactive terminated polydiene (B1).

### Amount of Long-Chain Hydrocarbon Group-Containing Phenol (C)

The amount of the long-chain hydrocarbon group-containing phenol (C) may be 0.1 wt % or more, 0.3 wt % or more, 0.5 wt % or more, 1 wt % or more, 1.5 wt % or more, 3 wt % or more, or 5 wt % or more, and is preferably 0.5 wt % or more in the adhesive. The amount of the long-chain hydrocarbon group-containing phenol (C) may be 20 wt % or less, 10 wt % or less, 5 wt % or less, 3 wt % or less, 2 wt % or less, or 1 wt % or less, and is preferably 10 wt % or less in the adhesive.

### Amount of Rubber Particles (D)

The amount of the rubber particles (D) may be 1% by weight or more, 3% by weight or more, 5% by weight or more, 7% by weight or more, 9% by weight or more, or 10% by weight or more, and is preferably 5% by weight or more in the adhesive. The amount of the rubber particles (D) may be 50 wt % or less, 40 wt % or less, 30 wt % or less, 20 wt % or less, 15 wt % or less, or 10 wt % or less in the adhesive.

### Amount of Filler (E)

The amount of the filler (E) may be 10 wt % or more, 20 wt % or more, 30 wt % or more, 40 wt % or more, 50 wt % or more, or 60 wt % or more, and is preferably 30 wt % or more in the adhesive. The amount of the filler (E) may be 90 wt % or less, 80 wt % or less, 70 wt % or less, 60 wt % or less, 50 wt % or less, or 40 wt % or less in the adhesive.

### Total Amount of Other Components (F)

The total amount of the other components (F) or each amount may be appropriately selected according to each component. For example, the total amount of other components (F) or each amount may be 0.1 wt % or more, 0.5 wt % or more, 1 wt % or more, 3 wt % or more, 5 wt % or more, or 10 wt % or more in the adhesive. The total amount of the other components (F) or each amount may be 20 wt % or less, 15 wt % or less, 10 wt % or less, 5 wt % or less, 2.5 wt % or less, or 1 wt % or less with respect to the adhesive.

### <Use as Adhesive>

The method for preparing the adhesive may be any method as long as various components can be uniformly dispersed and mixed. The adhesive can be obtained by kneading the components using a mixer such as a planetary mixer. Defoaming may be performed as necessary in preparation.

The adhesive may be of a one-component type, or may be of a two-component type or a multi-component type, but the adhesive of the present disclosure is suitably used as a two-component type or a multi-component type. When the adhesive of the present disclosure is of a two-component type or a multi-component type, curing may be allowed to proceed by mixing the epoxy resin (A) and the curing agent (B), which have been stored independently, upon use. After mixing, the adhesive is applied to one or both of the substrates to be bonded.

While the adhesive of the present disclosure may be thermally cured, the adhesive of the present disclosure can be cured at a relatively low curing temperature, for example, 75° C. or lower, 60° C. or lower, 50° C. or lower, 40° C. or lower, 30° C. or lower, or room temperature (for example, 15° C. to 35° C.). The curing temperature may be −10° C. or higher, −5° C. or higher, 0° C. or higher, 5° C. or higher, 10° C. or higher, 15° C. or higher, 20° C. or higher, or 25° C. or higher. The curing temperature here is the temperature of the adhesive or the environment at the start of curing, and does not mean the temperature of the adhesive after a temperature rise due to heat generation accompanying curing. For example, when the main agent and the curing agent are mixed as the adhesive of the present disclosure under a room temperature environment, heat may be generated so that the temperature of the adhesive reaches up to about 40° C. by mixing, but the curing temperature in this case is room temperature. In general, in a production site where use of an adhesive is assumed, it is not possible or not easy due to equipment to perform thermal curing after applying the adhesive, or the substrate cannot withstand heating in many cases. In this respect, the adhesive of the present disclosure is advantageous because it can be cured even at room temperature and exhibits good adhesiveness.

The curing time varies depending on the temperature, but may be, for example, 10 minutes or more, 1 hour or more, 3 hours or more, 6 hours or more, 12 hours or more, or 24 hours or more, and may be 48 hours or less, 24 hours or less, 12 hours or less, 6 hours or less, 3 hours or less, or 1 hour or less. In the case of curing at room temperature, the curing time may be 1 hour or more, 3 hours or more, or 6 hours or more.

The adhesive of the present disclosure can be used to join various substrates together. Examples of the substrate include inorganic substrates such as a glass, a glass ceramic, concrete, mortar, a brick, a tile, gypsum, and a natural stone (for example, granite or marble); a metal or an alloy such as steel, aluminum, iron, copper, titanium, magnesium, or a plated metal; organic substrates such as wood, various resins (such as PVC, polycarbonate, PMMA, polyester, and an epoxy resin), a glass fiber reinforced plastic (GFP), and a carbon fiber reinforced plastic (CFP); a coated substrate such as a powder-coated metal or resin. The substrates to be bonded may be of different materials or materials of the same quality. Preferably, the adhesive can be used for bonding metal substrates such as metal-metal, metal-glass, and metal-plastic.

The adhesive of the present disclosure can be used for automobiles, industrial machines, home electric appliances, and building components, and is, for example, suitable for repairing vehicles. Examples thereof include bonding in repair or attachment of various interior parts or exterior parts such as a wheel arch, a door, a fender, a window glass, a plastic cover, a flange, a bumper, and a tire.

In general, in a production site where use of an adhesive is assumed, even when the number of human resources and facilities is not sufficient, there are many cases where multiple objects are simultaneously bonded in order to efficiently proceed with the work, and an adhesive capable of ensuring a long usable time (open time or pot life) has been required. In particular, in some regions (for example, Japan), in the automobile repair industry (automobile maintenance), the number of new automobile maintenance workers has decreased because young people have lost interest in automobiles, and the shortage of technicians has occurred, and an adhesive capable of ensuring a long usable time has been particularly required. Conventional adhesives (in particular, two-component type epoxy adhesives) have a short usable time and are insufficient from the viewpoint of ensuring the working time, have insufficient adhesiveness, or are not necessarily sufficient to achieve both good adhesiveness and securing the usable time. The adhesive in the present disclosure enables good adhesiveness and usable time, and therefore is particularly suitable in the case of simultaneously bonding multiple objects.

In recent years, the regulation of poisonous and deleterious substances has become strict, but the curing agent (B) or the adhesive of the present disclosure can eliminate or reduce the use of poisonous and deleterious substances, and can also be excellent in safety.

Although the embodiments have been described above, it will be understood that various changes in form and details can be made without departing from the spirit and scope of the claims.

### EXAMPLES

Hereinafter, the present disclosure will be described in detail with reference to examples, but the present disclosure is not limited to these examples.

The procedures of the evaluation tests are as follows.

### [Pot Life]

Onto a glass plate, 3 g of each adhesive is applied, a PE sheet is placed on top and stuck using a spacer so that the thickness of the adhesive is about 1 mm. The time when the PE sheet was peeled off after being left in an atmosphere of 23° C. and the adhesion disappeared was defined as the pot life.

### [Curing Rate]

Evaluation was performed in accordance with JIS K 6850:1999 (test speed: 5 mm/min). A test specimen used for the measurement was prepared as follows. A cold rolled steel sheet (SPCC steel sheet) having a width of 25 mm×a length of 100 mm×a thickness of 1.6 mm was sanded (#120), degreased with an organic solvent such as acetone, then the adhesive composition of each example was applied, and the SPCC steel sheets were bonded together so as to have a width of 25 mm×a length of 12.5 mm×a thickness of 0.18 mm. Thereafter, the adhesive composition was cured under the condition of 23° C. for 24 hours, and the tensile shear bond strength was measured.

### [Shear Bond Strength]

The tensile shear bond strength was measured in accordance with JIS K 6850:1999 (test speed 5 mm/min, initial). A test specimen used for the measurement was prepared as follows. A cold rolled steel sheet (SPCC steel sheet) having a width of 25 mm×a length of 100 mm×a thickness of 1.6 mm was sanded (#120), degreased with an organic solvent such as acetone, then the adhesive of each example was applied, and the SPCC steel sheets were bonded together so as to have a width of 25 mm×a length of 12.5 mm. Thereafter, the adhesive was cured under the condition of 23° C. for 4 days to obtain a test specimen. Further, the tensile shear bond strength in accordance with JIS K 6850:1999 was measured in the same manner also for the test specimen after the obtained test specimen was left at 50° C. and 95% RH for 30 days (test speed: 5 mm/min). For each example, three test specimens were subjected to a tensile shear bond strength test, and the average value was described as the shear strength. The ratio of cohesive fracture (CF) between the adhesives and the ratio of peeling at the interface (AF) between the SPCC steel sheet and the adhesive were visually checked for each test specimen after fracture. The numerical values after “CF” and “AF” are the percentage of the area occupied by the cohesive fracture (CF) and the adhesive fracture (AF) with respect to the entire area where the bond is fractured (the same applies hereinafter).

### [Peel Bond Strength]

The peel bond strength was measured in accordance with JIS K 6854:1999. As the steel sheet, a cold-rolled steel sheet (SPCC) having a size of a width 25 mm×a length 200 mm x a thickness 0.8 mm was used. First, a steel sheet is sanded (#120), degreased with an organic solvent such as acetone, and then an adhesive is applied only to a portion having a length of 150 mm, and the remaining portion having a length of 50 mm is deformed by about 90° to prepare an L-shaped steel sheet (the adhesive may be applied after being deformed in advance). Another L-shaped steel sheet to which an adhesive is not applied is prepared. The two steel sheets are press-bonded with the adhesive interposed therebetween. The two sheets are fixed with a clip or the like. Subsequently, the adhesive is cured under the condition of 23° C. for 4 days, and the obtained T-shaped test piece is used for the test. The adhesive-free portion (50 mm portion) of the T-shaped test piece is fixed by gripping with tensile tester chucks (a distance between the chucks is desirably about 25 mm). The tensile speed is set to about 200 mm/min and measurement is performed until the remainder of the bonded portion is about 10 mm. A graph in which the horizontal axis represents a displacement (mm) and the longitudinal axis represents a load (N) is created, and an average value of the displacement between about 50 mm and 200 mm is calculated as a measured value. In addition, the peel bond strength in accordance with JIS K 6854:1999 was measured in the same manner also for the test specimen after the obtained test specimen was left at 50° C. and 95% RH for 30 days (test speed: 200 mm/min). The peel strength was measured in the same manner as the initial peel strength, and was defined as the peel strength after high-temperature and high-humidity storage (unit: N/25 mm). The ratio of cohesive fracture (CF) between the adhesives and the ratio of peeling at the interface (AF) between the SPCC steel sheet and the adhesive were visually checked for each test specimen after fracture.

The raw materials used are as shown in Table 1-1 and Table 1-2.

TABLE 1-1

| | Raw materials (remarks) | Product name (supplier) |
|---|---|---|
| Main | Bisphenol A type epoxy resin (epoxy equivalent: 189) | jER828 (Mitsubishi Chemical) |
| agent | Dimer acid glycidyl ester (epoxy equivalent: 430) | jER871 (Mitsubishi Chemical) |
| | Polypropylene skeleton epoxy resin (epoxy equivalent: 300) | ED-506 (ADEKA) |
| | Polybutadiene rubber particles 40% dispersed bisphenol | MX-150 (KANEKA) |
| | A type epoxy resin (epoxy equivalent: 307) | |
| | Acrylonitrile butadiene rubber-modified epoxy resin | TSR-960 (DIC) |
| | (epoxy equivalent: 240) | |
| | Urethane-modified epoxy resin (epoxy equivalent: 220) | EPU-78-11 (ADEKA) |
| | Blocked urethane prepolymer | Polyether polyol (EL-5030 (trade name) manufactured by Asahi |
| | (produced by production method described on right) | Glass Co., Ltd., molecular weight: 5,000, functionality: 3) (100 |
| | | parts) and MDI (NCO/OH = 2.2) (16.4 parts) were allowed to |
| | | react at 80° C. for 5 hours to obtain a terminal NCO-containing |
| | | urethane prepolymer. Thereafter, in the presence of dibutyltin |
| | | dilaurate (0.008 parts), methyl ethyl ketoxime (6.5 parts) was |
| | | allowed to react at 50° C. for 5 hours, and disappearance of NCO |
| | | was checked by IR to obtain a blocked urethane prepolymer. |
| | Cardanol | Cardolite NX-2021 (Cardolite) |
| | 3-Glycidoxypropyltrimethoxysilane (epoxy equivalent: 236) | KBM-403 (Shin-Etsu Chemical) |
| | Heavy calcium carbonate | Whiton B (Shiraishi Calcium) |
| | Hollow glass balloons | Glass Bubbles S38 (3M) |
| | (volume average particle diameter: 40 μm) | |
| | Glass beads (particle size: 125 to 180 μm) | M-9 (Potters-Ballotini) |
| | Hydrophobic silica | Cabo-Sil TS-720 |
| | | (Cabot Specialty Chemicals Inc) |

TABLE 1-2

| | Raw materials (remarks) | Product name (supplier) |
|---|---|---|
| Curing | Amino group-terminated acrylonitrile butadiene | ATBN 1300 × 16 |
| agent | rubber (active hydrogen equivalent: 900) | (CVC THERMOSET SPECIALITIES) |
| | Polyoxypropylenediamine | Jeffamine D-2000 (Huntsman) |
| | (Mw2000) (active hydrogen equivalent: 514) | |
| | Polyoxypropylenediamine | Jeffamine D-400 (Huntsman) |
| | (Mw430) (active hydrogen equivalent: 110) | |
| | Modified alicyclic polyamine | ANCAMINE 2143 (EVONIC) |
| | (active hydrogen equivalent: 118) | |
| | Modified aliphatic polyamine | Fujicure FXJ-8077 (T&A TOKA) |
| | (active hydrogen equivalent: 75) | |
| | Modified polyamine (active hydrogen equivalent: 66) | Cardolite NX-5567 (Cardolite) |
| | 2,4,6-Tris[(dimethylamino)methyl]phenol | 2,4,6-Tris(dimethylamino)methylphenol |
| | | (Tokyo Chemical Industry) |
| | Phenol salt of DBU | U-CAT SA1 (San-Apro) |
| | DBU | DBU (San-Apro) |
| | 2-Ethylhexanoate of DBU | U-CAT SA102 (San-Apro) |
| | N-2-(aminocthyl)-3-aminopropyltrimethoxysilane | KBM-603 (Shin-Etsu Chemical) |
| | (active hydrogen equivalent: 74) | |
| | Carbon black | HI-BLACK20 (Korea Carbon Black) |

### Examples 1 to 14 and Comparative Examples 1 to 3

The components were mixed according to the formulation shown in Tables 2-1 to 2-3 to obtain each of a main agent and a curing agent. Thereafter, the main agent and the curing agent were mixed together to prepare an adhesive. The evaluation tests were performed using the obtained adhesive. The results are shown in Table 2-4.

TABLE 2-1

| | | Example | | | | | | | | |
|---|---|---|---|---|---|---|---|---|---|---|
| | Components | 1 | 2 | 3 | 4 | 5 | 6 | 7 | 8 | 9 |
| Main | Bisphenol A type epoxy resin | 22 | 22 | 22 | 22 | 22 | 22 | 22 | 22 | 22 |
| agent | Dimer acid glycidyl ester | | | | | | | 5 | 5 | |
| | Polypropylene skeleton epoxy resin | 3 | 3 | 3 | 3 | 3 | 3 | | | 3 |
| | Polybutadiene rubber particles 40% | 22 | 22 | 22 | 22 | 22 | 22 | 22 | 22 | 22 |
| | dispersed bisphenol A type epoxy resin | | | | | | | | | |
| | Acrylonitrile butadiene rubber-modified | | | | | | | | | |
| | epoxy resin | | | | | | | | | |
| | Urethane-modified epoxy resin | | | | | | | | | |
| | Blocked urethane prepolymer | | | | | | | | | |
| | Cardanol | 2 | 2 | 2 | 2 | 2 | 2 | 1 | 0 | 2 |
| | 3-Glycidoxypropyltrimethoxysilane | 0.1 | 0.1 | 0.1 | 0.1 | 0.1 | 0.1 | 0.1 | 0.1 | 0.1 |
| | Heavy calcium carbonate | 17 | 17 | 17 | 17 | 17 | 17 | 17 | 17 | 17 |
| | Hollow glass balloons | 1 | 1 | 1 | 1 | 1 | 1 | 1 | 1 | 1 |
| | (volume average particle diameter: 40 μm) | | | | | | | | | |
| | Glass beads | 1.9 | 1.9 | 1.9 | 1.9 | 1.9 | 1.9 | 1.9 | 1.9 | 1.9 |
| | Hydrophobic silica | 1 | 1 | 1 | 1 | 1 | 1 | 1 | 1 | 1 |
| | Total of main agent | 70 | 70 | 70 | 70 | 70 | 70 | 71 | 70 | 70 |

| | | Example | | | | | Comparative Example | | |
|---|---|---|---|---|---|---|---|---|---|
| | Components | 10 | 11 | 12 | 13 | 14 | 1 | 2 | 3 |
| Main | Bisphenol A type epoxy resin | 22 | 22 | 22 | 22 | 37 | 22 | 22 | 22 |
| agent | Dimer acid glycidyl ester | | | | | | | | |
| | Polypropylene skeleton epoxy resin | 3 | 3 | 3 | 3 | 3 | 3 | 3 | 3 |
| | Polybutadiene rubber particles 40% | 22 | 22 | | | | 22 | 22 | |
| | dispersed bisphenol A type epoxy resin | | | | | | | | |
| | Acrylonitrile butadiene rubber-modified | | | 17 | | | | | |
| | epoxy resin | | | | | | | | |
| | Urethane-modified epoxy resin | | | | 18 | | | | 18 |
| | Blocked urethane prepolymer | | | | | 8 | | | |
| | Cardanol | 2 | 2 | 2 | 2 | 2 | 2 | 2 | 2 |
| | 3-Glycidoxypropyltrimethoxysilane | 0.1 | 0.1 | 0.1 | 0.1 | 0.1 | 0.1 | 0.1 | 0.1 |
| | Heavy calcium carbonate | 17 | 17 | 17 | 17 | 17 | 17 | 17 | 17 |
| | Hollow glass balloons | 1 | 1 | 1 | 1 | 1 | 1 | 1 | 1 |
| | (volume average particle diameter: 40 μm) | | | | | | | | |
| | Glass beads | 1.9 | 1.9 | 1.9 | 1.9 | 1.9 | 1.9 | 1.9 | 1.9 |
| | Hydrophobic silica | 1 | 1 | 1 | 1 | 1 | 1 | 1 | 1 |
| | Total of main agent | 70 | 70 | 65 | 66 | 71 | 70 | 70 | 66 |

Numerical values represent parts by weight

TABLE 2-2

| | | Example | | | | | | | | | | | | | | Comparative Example | | |
|---|---|---|---|---|---|---|---|---|---|---|---|---|---|---|---|---|---|---|
| | Components | 1 | 2 | 3 | 4 | 5 | 6 | 7 | 8 | 9 | 10 | 11 | 12 | 13 | 14 | 1 | 2 | 3 |
| Curing | Amino group-terminated | 10 | 12 | 8 | 10 | 10 | 10 | 10 | 10 | 10 | 10 | 10 | 10 | 10 | 10 | | 10 | 10 |
| agent | acrylonitrile butadiene rubber | | | | | | | | | | | | | | | | | |
| | (active hydrogen equivalent: 900) | | | | | | | | | | | | | | | | | |
| | Polyoxypropylenediamine | | | | | | | | | | | | | | | 5 | | |
| | (Mw2000)(active hydrogen | | | | | | | | | | | | | | | | | |
| | equivalent: 514) | | | | | | | | | | | | | | | | | |
| | Polyoxypropylenediamine | 5 | 6 | 4 | 5 | 5 | 5 | 5 | 5 | 5 | 5 | 5 | 5 | 5 | 5 | 5 | 5 | 5 |
| | (Mw430)(active hydrogen | | | | | | | | | | | | | | | | | |
| | equivalent: 110) | | | | | | | | | | | | | | | | | |
| | Modified alicyclic polyamine | 13 | 15.6 | 10.4 | 6 | | 4 | 13 | 13 | 13 | 13 | 13 | 13 | 13 | 13 | 13 | 13 | 13 |
| | (active hydrogen equivalent: 118) | | | | | | | | | | | | | | | | | |
| | Modified aliphatic polyamine | | | | 5 | 6 | | | | | | | | | | | | |
| | (active hydrogen equivalent: 75) | | | | | | | | | | | | | | | | | |
| | Modified polyamine | | | | | 3 | 5 | | | | | | | | | | | |
| | (active hydrogen equivalent: 66) | | | | | | | | | | | | | | | | | |
| | 2,4,6-Tris(dimethylamino- | 2 | 2.4 | 1.6 | 2 | 2 | 2 | 2 | 2 | 2 | 2 | 2 | 2 | 2 | 2 | 2 | 2 | 2 |
| | methyl)phenol | | | | | | | | | | | | | | | | | |
| | Phenol salt of DBU | 1 | 1.2 | 0.8 | 1 | 1 | 1 | 1 | 1 | 0.5 | | | 1 | 1 | 1 | 1 | | |
| | DBU | | | | | | | | | | 1 | | | | | | | |
| | 2-Ethylhexanoate of DBU | | | | | | | | | | | 1 | | | | | | |
| | N-2-(aminoethy1)-3- | 1 | 1.2 | 0.8 | 1 | 1 | 1 | 1 | 1 | 1 | 1 | 1 | 1 | 1 | 1 | 1 | 1 | 1 |
| | aminopropyltrimethoxysilane | | | | | | | | | | | | | | | | | |
| | (active hydrogen equivalent: 74) | | | | | | | | | | | | | | | | | |
| | Carbon black | 1 | 1.2 | 0.8 | 1 | 1 | 1 | 1 | 1 | 1 | 1 | 1 | 1 | 1 | 1 | 1 | 1 | 1 |
| | Total of curing agent | 33 | 39.6 | 26.4 | 31 | 29 | 29 | 33 | 33 | 32.5 | 33 | 33 | 33 | 33 | 33 | 28 | 32 | 32 |

Numerical values represent parts by weight

TABLE 2-3

| | Example | | | | | | | | |
|---|---|---|---|---|---|---|---|---|---|
| | 1 | 2 | 3 | 4 | 5 | 6 | 7 | 8 | 9 |
| Total of main agent + curing agent (parts by weight) | 103 | 109.6 | 96.4 | 101 | 99 | 99 | 104 | 103 | 102.5 |
| Epoxy group/active hydrogen ratio (mol ratio) | 1.1 | 0.92 | 1.38 | 1.06 | 1.02 | 1.1 | 1.11 | 1.11 | 1.1 |

| | Example | | | | | Comparative Example | | |
|---|---|---|---|---|---|---|---|---|
| | 10 | 11 | 12 | 13 | 14 | 1 | 2 | 3 |
| Total of main agent + curing agent (parts by weight) | 103 | 103 | 98 | 99 | 104 | 98 | 102 | 98 |
| Epoxy group/active hydrogen ratio (mol ratio) | 1.1 | 1.1 | 1.1 | 1.16 | 1.14 | 1.11 | 1.1 | 1.16 |

TABLE 2-4

| | | Example | | | | | | | | |
|---|---|---|---|---|---|---|---|---|---|---|
| | | 1 | 2 | 3 | 4 | 5 | 6 | 7 | 8 | 9 |
| Pot life (min) (23° C.) | | 240 | 210 | 270 | 240 | 240 | 240 | 240 | 240 | 240 |
| Curing rate (MPa) | | 19 | 19 | 18 | 19 | 19 | 20 | 19 | 19 | 19 |
| (23° C., 24 hours) | | CF100 | CF80 | CF90 | CF100 | CF100 | CF100 | CF100 | CF80 | CF90 |
| | | | AF20 | AF10 | | | | | AF20 | AF10 |
| Shear | Initial | 72 | 20 | 20 | 21 | 22 | 21 | 22 | 20 | 21 |
| strength | | CF100 | CF90 | CF90 | CF100 | CF100 | CF100 | CF100 | CF100 | CF100 |
| (MPa) | | | AF10 | AF10 | | | | | | |
| | Moisture | 20 | 10 | 19 | 20 | 20 | 20 | 19 | 36 | 12 |
| | resistance | CF90 | CFBD | CF80 | CF90 | CF93 | CF95 | CF80 | CF40 | CFSO |
| | after 30 days | AF10 | AF20 | AF20 | AF10 | AFS | AFS | AF20 | AF60 | AF20 |
| Peel | Initial | 128 | 118 | 130 | 130 | 129 | 128 | 125 | 110 | 128 |
| strength | | CF100 | CF100 | CF30 | CF100 | CF100 | CF100 | CF100 | CF90 | CF100 |
| (N/25 mm) | | | | AF30 | | | | | AF10 | |
| | Moisture | 127 | 120 | 130 | 127 | 128 | 127 | 115 | 90 | 117 |
| | resistance | CF100 | CF100 | CF70 | CF100 | CF100 | CF100 | CF80 | CF30 | CF90 |
| | affer 30 days | | | AF30 | | | | AF20 | AF70 | AF10 |

| | | Example | | | | | Comparative Example | | |
|---|---|---|---|---|---|---|---|---|---|
| | | 10 | 11 | 12 | 13 | 14 | 1 | 2 | 3 |
| Pot life (min) (23° C.) | | 240 | 240 | 240 | 270 | 210 | 210 | 240 | 270 |
| Curing rate (MPa) | | 18 | 18 | 19 | 19 | 20 | 17 | 18 | 19 |
| (23° C., 24 hours) | | CF90 | CF70 | CFIDO | CF100 | CF80 | CF30 | CF80 | CF80 |
| | | AF10 | AF30 | | | AF20 | AF70 | AF20 | AF20 |
| Shear | Initial | 22 | 20 | 20 | 20 | 21 | 18 | 20 | 20 |
| strength | | CF100 | CF100 | CF100 | CF100 | CF100 | CF60 | CF100 | CF100 |
| (MPa) | | | | | | | AF40 | | |
| | Moisture | 18 | 16 | 16 | 17 | 16 | 12 | 12 | 14 |
| | resistance | | OF30 | CF30 | CF40 | CE50 | CF20 | CF20 | CF10 |
| | after 30 days | AF30 | AF70 | AF70 | AFGO | AF50 | AFSO | AF80 | AF90 |
| Peel | Initial | 125 | 120 | 115 | 123 | 121 | 67 | 112 | 110 |
| strength | | CF100 | CF100 | CF100 | CF100 | CF100 | AF100 | CF90 | CF90 |
| (N/25 mm) | | | | | | | | AF10 | AF10 |
| | Moisture | 97 | 92 | 95 | 90 | 93 | 35 | 50 | 55 |
| | resistance | CF60 | CF40 | CF20 | CFSO | CF60 | AF100 | CF10 | CF10 |
| | affer 30 days | AF40 | AF60 | AF80 | AF50 | AF40 | | AF80 | AF90 |

1. A curing agent (B) for an epoxy resin, comprising:
a reactive terminated polydiene (B1);
a reactive polyamine (B2); and
an amidine (B3).

2. The curing agent (B) according to claim 1, wherein the reactive terminated polydiene (B1) has a repeating unit derived from acrylonitrile, and a terminal reactive group is at least one group selected from a group consisting of a hydroxy group, a carboxy group, and an amino group.

3. The curing agent (B) according to claim 1, wherein the reactive terminated polydiene (B1) is a butadiene-acrylonitrile copolymer having an amino group at a terminal, and has an active hydrogen equivalent of 500 or more and 2,000 or less.

4. The curing agent (B) according to claim 1, wherein the reactive polyamine (B2) comprises a polyether polyamine (B2-1) and a non-polyether-modified polyamine (B2-2).

5. The curing agent (B) according to claim 1, wherein the amidine (B3) is a bicyclic heterocyclic compound and is a tertiary amine having no primary amino group and no secondary amino group.

6. The curing agent (B) according to claim 1, wherein the amidine (B3) is a phenol salt of diazabicycloundecene or a phenol salt of diazabicyclononene.

7. The curing agent (B) according to claim 1, further comprising a non-amidine tertiary amine (B4) having no primary amino group and no secondary amino group.

8. The curing agent (B) according to claim 1, further comprising an amino group-containing silane coupling agent (B5).

9. The curing agent (B) according to claim 1, wherein, with respect to 100 parts by weight of the reactive terminated polydiene (B1),
an amount of the reactive polyamine (B2) is 10 parts by weight or more and 300 parts by weight or less, and
an amount of the amidine (B3) is 1 part by weight or more and 100 parts by weight or less.

10. An adhesive, comprising:
an epoxy resin (A); and
a curing agent (B),
wherein the curing agent (B) comprises
a reactive terminated polydiene (B1),
a reactive polyamine (B2), and
an amidine (B3).

11. The adhesive according to claim 10, wherein the adhesive is of a two-component type or a multi-component type in which the epoxy resin (A) and the curing agent (B) are mixed upon use.

12. The adhesive according to claim 10, wherein curing is performed at a curing temperature of 75° C. or lower.

13. The adhesive according to claim 10, comprising a long-chain hydrocarbon group-containing phenol (C).

14. The adhesive according to claim 13, wherein an amount of the long-chain hydrocarbon group-containing phenol (C) is 0.5 wt % or more and 10 wt % or less in the adhesive.

15. The adhesive according to claim 10, comprising rubber particles (D).

16. The adhesive according to claim 10, wherein a ratio of a number of epoxy groups to a number of active hydrogen of an amine in the adhesive is 0.5 to 2.0.
